(19) United States
(12) Patent Application Publication
(10) Pub. No.: US 2021/0087345 A1
(43) Pub. Date: Mar. 25, 2021

(54) REDUCED PARTICLE AGGLOMERATION FOR PACKAGING FILMS

(71) Applicant: Bemis Company, Inc., Neenah, WI (US)

(72) Inventors: Ankush A. Gokhale, Menasha, WI (US); Kevin P. Nelson, Appleton, WI (US); Christopher V. Trave, Appleton, WI (US)

(21) Appl. No.: 16/958,380

(22) PCT Filed: Dec. 27, 2017
(86) PCT No.: PCT/US2017/068541

§ 371 Date: Jun. 26, 2020

(51) Int. Cl. C08J 5/18; C08K 5/00; C08K 5/098; C08L 23/08; C08J 3/205; B32B 27/08; B32B 27/30; B32B 27/20

(52) U.S. Cl. CPC C08J 5/18; C08K 5/0058; C08K 5/098; C08L 23/0853; C08J 3/2053; B32B 27/08; B32B 2307/7145; B32B 27/20; B32B 2307/40; B32B 2307/7244; B32B 2439/46; C08J 2323/08; B32B 2307/758; B32B 27/306

(57) ABSTRACT

Water soluble particles can be incorporated into articles that are produced from a polymer based matrix with reduced appearance implications. Using a specific formulation including a water permeable polymer, water soluble particles and a surfactant, and a specific process for combining these components, agglomeration of the particles can be reduced. This is particularly useful for applications where the particles are incorporated into packaging films and extracted upon exposure to moist products.

### TECHNICAL FIELD

This application relates to the field of packaging, specifically the production of flexible polymer based multilayer packaging films that incorporate water soluble particles in the product contact layer. These films have improved appearance due to reduced particle agglomeration.

### BACKGROUND

Various types of particles can be incorporated into polymer based matrices. These particles are typically included to provide enhancements to the physical properties of the polymer. In some cases, the particles are embedded into the polymer in order to be available for extraction at a later time.

The particles can be incorporated into the polymer matrix by way of liquid injection compounding, as described in U.S. Pat. No. 7,993,560, Nelson et al., incorporated herein by reference. A liquid plus additive solution is introduced into the polymer melt stream and most of the liquid is removed at a subsequent venting port. Any component within the original liquid solution remains dispersed in the polymer matrix after the volatilized portion is removed.

Useful articles can be manufactured from the compounded polymer. The particles incorporated into the polymer can improve the article properties. Improvements can be appearance characteristics such as color, mechanical characteristics such as crack resistance or pliability, surface characteristics such as COF, or cost related such as density reduction. It has also been contemplated that particles can be dispersed into a polymer matrix for the purpose of being extracted at a later time.

Using liquid injection compounding or other compounding techniques, it can be difficult to incorporate particles into a polymer matrix so that they are evenly distributed. The particles may have a tendency to prefer to stick to themselves and form agglomerations prior to and during the compounding process. These agglomerations can be large enough that they can be seen with the naked eye. The article enhancement provided by the addition of the particle may be reduced and the appearance of the polymer article may be affected due to the agglomerations. Many compounding processes use aggressive mixing sections or multiple passes to overcome this tendency and help incorporate and distribute the particles. This can be costly and ineffective.

### SUMMARY

A solution is desired to assist in reducing the agglomeration of the particles in the polymer matrix and the final article. With this solution, it is desired to incorporate a water soluble particle into a polymer matrix to be available for extraction at a later point in time. Ideally, the particle can be extracted from a packaging film that has the particle containing polymer matrix on the product contact surface. Extraction can occur when a moist food product comes into contact with the product contact surface of the packaging film. Herein is described a process for compounding a water soluble particle into a polymer matrix, the compounded resin and the packaging film made therefrom, all with reduced particle agglomerations. The reduction in particle agglomerations produces a more aesthetically pleasing packaging film.

A process for producing a compounded resin useful for producing reduced aggregate packaging film is described herein. The process has the steps of i) introducing an ethylene vinyl acetate copolymer composition into an extruder, ii) heating the ethylene vinyl acetate copolymer composition to a temperature sufficient to form a polymer melt, iii) introducing into the extruder a liquid comprising water, water soluble particles and a surfactant, iv) mixing the liquid with the polymer melt in the extruder to form a mixture of the liquid and the polymer melt, v) vaporizing at least a portion of the water and removing it from the polymer melt, resulting in a mixture of the polymer melt, the water soluble particles and the surfactant and vi) extruding the resultant mixture through an extruder die to produce a compounded resin. A packaging film may be produced from the compounded resin.

An embodiment of a compounded resin has a high moisture transmission polymer, ii) between 0.5 and 20 weight percent of a water soluble particle dispersed in the high moisture transmission polymer and iii) a surfactant. A packaging film may be produced from the compounded resin, wherein any agglomerations of water soluble particles in the packaging film have a size equal to or less than 1.0 mm² when measured using a size estimation chart as described in TAPPI test method T564. A packaging film may be produced from the compounded resin, wherein any agglomerations of water soluble particles in the packaging film have a size equal to or less than 0.8 mm².

An embodiment may be a packaging film comprising a product contact layer that has i) a high moisture transmission polymer, ii) at least 0.08 g/m² of a water soluble particle dispersed in the high moisture transmission polymer, and iii) a surfactant. Any agglomerations of water soluble particles in the packaging film may have a size of equal to or less than 1.0 mm² when measured using a size estimation chart as described in TAPPI test method T564.

Any of the embodiments of packaging films may have a high moisture transmission polymer that is ethylene vinyl acetate copolymer. The ethylene vinyl acetate copolymer may have a vinyl acetate content of at least 18%.

Any of the embodiments of packaging film may have a water soluble particle that is also water extractable. The average cumulative amount of water soluble particle extracted from the product contact layer upon contact with water after 2 days at 23° C. and 1 atm is greater than 40% of the initial amount of particle present in the product contact layer. The packaging film may have a water soluble particle that is a salt of sorbic acid.

Any of the embodiments of packaging films may have a surfactant that has an ethoxylation level of at least 10 moles per mole of surfactant. The surfactant may have a hydrophilic lipophilic balance (HLB) of at least 10.

The packaging films may have a haze level less than 35%. The packaging films may have a clarity level greater than 70%.

Another embodiment is a packaged product with a packaging film comprising a product contact layer that has i) an ethylene vinyl acetate copolymer, ii) a water soluble particle dispersed in the ethylene vinyl acetate copolymer, and iii) a surfactant. The packaged product may be a moist food product such as raw poultry. The water soluble particle may be an antimicrobial agent. The water soluble particle may be an odor reducing agent. The water soluble particle may be potassium sorbate.

### BRIEF DESCRIPTION OF THE DRAWINGS

FIG. 1 is a cross sectional drawing of an embodiment of a multilayer packaging film;

FIG. 2 is a top view drawing of an embodiment of a packaged product;

FIG. 3 is a representative drawing of a compounding process;

FIG. 4 is a cross sectional representation of the polymer melt within a section of a compounding process; and

FIG. 5 is a cross sectional representation of the polymer melt within a section of a compounding process.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Various embodiments of the methods, compositions, compounded resins, films and packages described herein provide one or more advantages relative to currently available or previously described methods, compositions, compounded resins, films and packages that incorporate water soluble particles. For example, some embodiments described in this application are directed to packaging films with reduced agglomeration of particles dispersed in a polymer matrix. Also described are embodiments of compounded resins and a process for producing compounded resins that could be used to produce the reduced agglomeration packaging films. Specifically, the processes described include steps that prevent particle agglomeration during the process of incorporating the particles into the polymer matrix. The compounded resins described can be incorporated into a packaging film that has superior appearance (e.g. low haze and high clarity). The embodiments described herein can be used to produce packages and packaging films that contain water soluble particles that are intended to be extracted by moisture when exposed to a moist food product.

Particles can be present as either primary particles or, most often, as particle agglomerations. Agglomerations are primary particles that have collected together. As used herein, “reduced agglomerations” refers to collections of particles that may be reduced in size (measured in area) or may be reduced in number at any given size or size range.

A particle containing packaging film has been described which has improved appearance over previously produced particle containing packaging films. The packaging film includes an ethylene vinyl acetate (EVA) copolymer based product contact surface. The EVA copolymer matrix also contains water soluble, water extractable particles and a surfactant. Preferably, the particles and surfactant are introduced into the EVA copolymer matrix using a liquid injection compounding process. Introduction of the surfactant to the water phase of the liquid injection compounding allows for improved surfactant activity and less agglomeration of the particles through the compounding process. The result is a more aesthetically pleasing packaging film, and overall packaged product, due to less visual disruption from large particle agglomerations. Improvements to the aesthetics are a more pleasing appearance, measured by haze and clarity type test protocol.

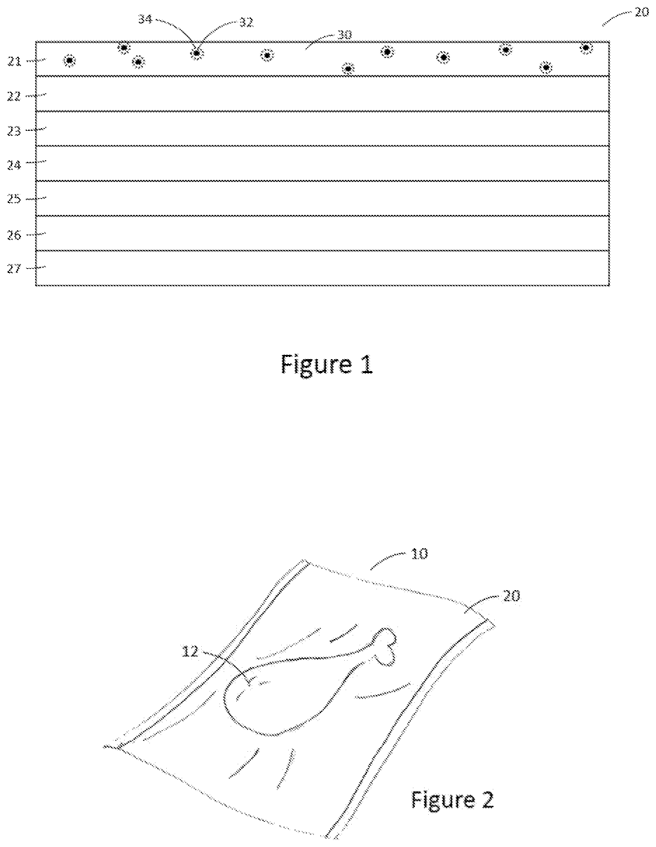

The packaging film can be a multilayer film as shown in FIG. 1. The water soluble particles (32) and surfactant (34) are located in at least the product contact layer (21) of the packaging film (20). The surfactant may be generally surrounding the water soluble particles (32) as shown in FIG. 1, but may also be somewhat distributed throughout the product contact layer (21). The packaging films may be a monolayer film of a product contact layer (not shown) or may be a multilayer film having a product-contact layer with additional layers (FIG. 1). As used herein, the term “product contact layer” is used to describe one of the exterior layers of a multilayer packaging film (or is the only layer of a single layer film) and is the layer that comes in contact with, or is closest to, the item being packaged. Typically, the product-contact layer of the packaging film is the inner surface of a packaging container formed from the packaging film. The thickness of the packaging film can vary from about 25.4 μm to 1270 μm (1 mil to 50 mil), or from about 38.1 μm to 254 μm (1.5 mil to 10 mil), or from about 50.8 μm to 127 μm (2 mil to 5 mil). The thickness of the product-contact layer can vary from about 2.54 μm to 127 μm (0.1 mil to 5 mil), or from about 5.08 μm to 50.8 μm (0.2 mil and 2 mil), or from about 12.7 μm to 25.4 μm (0.5 mil to 1 mil). As used herein, the term “layer” refers to a continuous or discontinuous thickness of material.

In addition to the water soluble particle (32) and the surfactant (34), the product contact layer (21) may also have a high moisture transmission polymer (30). A high moisture transmission polymer allows moisture to move within the product contact layer of a packaging film. In this manner, the water soluble particles within the product contact layer can be extracted from the film, traveling with the moisture as the moisture returns to the interior of the package. As used herein, “high moisture transmission polymers” are those that exhibit a moisture vapor transmission rate (MVTR) of at least 2 g·100 μm/m²·day (0.51 g·mil/100 in²·day) when formed into a film and tested according to ASTM F1249 (test conditions of 37.8° C. and 90% R.H.). Preferably the MVTR of the polymer is at least 3 g·100 μm/m²·day (0.76 g·mil/100 in²·day).

Ethylene polymers that incorporate comonomers that interfere with crystallization may have elevated water vapor transmission rates. Polar comonomers like vinyl acetate, ethylenically unsaturated alkyl acrylates and acids and their ionomers may exhibit high water vapor transmission rates. Non-polar comonomers like certain alpha olefins are also known to increase water transmission.

An example of a high moisture transmission polymer is ethylene vinyl acetate (EVA) copolymer. As used throughout this application, the term “ethylene vinyl acetate” or “EVA” refers to copolymers comprised of repeating units of ethylene and vinyl acetate. Ethylene vinyl acetate copolymers may be represented by the general formula: [(CH₂—CH₂)ₙ—((CH₂—CH(COO)(CH₃))ₘ]. The vinyl acetate content may vary from less than 2% to greater than 95% by weight (of total EVA composition). The vinyl acetate content of EVA copolymers for packaging applications may vary from 2% to 40% by weight. Typically, the vinyl acetate content of EVA copolymers for packaging application can vary from about 2% to 28% by weight. EVA copolymers are permeable to water vapors and the transmission rates increase as the vinyl acetate content increases. Using high vinyl acetate content EVA copolymers increases the flow of moisture in and out of the product contact layer, subsequently increasing the rate and overall level of water soluble particle extraction.

In addition to enhancing the extraction rates, higher vinyl acetate content EVA copolymers can also improve the appearance of the film. EVA copolymers with high vinyl acetate levels have lower haze and higher clarity in films because the vinyl acetate reduces crystallinity. Additionally, the dispersion of the water soluble particles within the EVA copolymer matrix is improved (less agglomeration of particles) as the vinyl acetate content increases. Without being bound by theory, it is thought that as vinyl acetate content increases and crystallinity decreases (i.e. amorphous content increases), there should be more free volume for nucleation and growth of particles (e.g., potassium sorbate particles). With more space, it is reasonable to expect the population of particles to rise and concurrently, the average size of the aggregated particles to fall. This mechanism should be valid for polar and nonpolar comonomers. Again, without being bound by theory, perhaps the polymer's polar groups preferentially associate with the cation/anion pairs that coalesce into particles as the water content decreases. Then, it is reasonable to expect that the population of particles will grow as polar comonomer content (e.g. vinyl acetate) grows. Again, a higher particle population should coincide with particle aggregations with a smaller average size. If this mechanism is real, non-polar comonomers would not show benefit.

Preferably, the vinyl acetate content of the EVA copolymer is at least 12%, more preferably, greater than about 18%.

As will be described below, the water solubility of the particle is important for both incorporation into the polymer matrix as well as the effective extraction of the particle from the polymer matrix upon exposure to a moist product. The degree of solubility required is dependent on the application and should be sufficient for efficient processing and the intended end use. For instance, the particle must solubilize enough to allow for efficient introduction during liquid injection compounding. Low solubility will require high amounts of water vaporization which may become difficult to control and costly.

The water soluble particle (32) can be dispersed in the product contact layer (21) of the packaging film (20) in such a manner that the individual particles have agglomerated at a very low level, producing very small particles and reducing the visual effect of the added particles on the film. In other words, the particle sizes are very small such that they cannot be easily seen by the naked eye and they have little effect on transmitted light. Haze and clarity can be improved by keeping the particle size as small as possible. Maximum size of the agglomerated particles can be 1 mm², 0.8 mm², 0.6 mm² or 0.4 mm² when measured using a size estimation chart as described in TAPPI Test Method 1564.

A variety of water soluble particles may be added to the polymer matrix in order to produce a polymer with certain desired properties. The particle may be, but is not restricted to, a colorant, flavoring, fragrance, antimicrobial, fungicide, antioxidant, protein, enzyme, antiblocking agent, odor absorber, reactive indicator compound or taggant. The water soluble particles may be an element or a compound and may be a single material or a blend of materials.

In some embodiments the water soluble particle is a salt with a cation and an anion. The cation may be selected from the following group: ammonium, lithium, sodium, potassium, rubidium, cesium, beryllium, magnesium, calcium, barium, strontium, aluminum, iron II, iron III, cobalt, nickel, copper I, copper II, zinc, silver and tin. The anion may be selected from the following group: halide, oxide, sulfide, phosphate, hydrogen phosphate, dihydrogen phosphate, pyrophosphate, polyphosphate, sulfate, hydrogen sulfate, pyrosulfate, sulfite, hydrogen sulfite, pyrosulfite, thiosulfate, thiosulfate, carbonate, hydrogen carbonate, tetraborate, metaborate, nitrate, nitrite, hydroxide and silicate. The water soluble particle may also include soluble polymers, acids, organic acids, the salts of those acids or certain other organic compounds like saccharides.

One embodiment uses potassium sorbate as the water soluble particle. The potassium sorbate particles are highly soluble in water (58.2% at 20° C.) and can be extracted from the product contact layer of a packaging film when a moist food product is packaged in it. The sorbate particles may provide antimicrobial and/or odor reduction functionality when used with raw poultry or other products. In this way, the shelf life of the packaged product can be extended. The packaged product may be acceptable for sale or consumption for an additional day or more.

In some preferred embodiments, the product contact layer comprises from about 0.08 g/m² to 9.3 g/m² (0.052 mg/in² to 6 mg/in²), or from about 0.155 g/m² to 1.55 g/m² (0.1 mg/in² to 1 mg/in²), or from about 0.31 g/m² to 1.24 g/m² (0.2 mg/in² to 0.8 mg/in²) of added particles. In some preferred embodiments, the product contact layer comprises from about 0.1 wt. % to 15 wt %, or from about 0.5 wt. % to 10 wt. %, or from about 1 wt. % to 5 wt. % of added particles, relative to the total weight of the product contact layer.

In some preferred embodiments, the compounded polymer comprises from about 0.1 wt. % to 30 wt. %, or from about 0.5 wt. % to 20 wt. %, or from about 1 wt. % to 10 wt. % of added particles, relative to the total weight of the compounded polymer.

The preferred process for incorporating the water soluble particle and surfactant into the high moisture transmission polymer is a liquid injection compounding process. This process is similar to a typical polymer compounding process in that a polymer is fed into the feed station, the polymer travels through the extruder, experiencing melting by heat and blending by mechanical mixing zones before being formed into a shape and re-solidified. Liquid injection compounding introduces additives to the polymer melt stream by way of a liquid. After being introduced into the compounding unit, much of the liquid component is volatilized by the heat of the polymer melt and compounding equipment and the volatilized gasses are vented from the system. Any portions of the liquid that are not volatilized remain within the polymer melt and are incorporated into the final compounded resin product. In the case of introducing a water soluble particle via the liquid injection compounding process, the liquid phase can be water and the water soluble particle can be completely dissolved in the water. Preferably, the surfactant is also added to the liquid to be injected. In such a system, much of the water is volatilized, leaving the water soluble particles and surfactant within the compounded resin.

Water soluble particles generally remain as individual particles when dissolved in water. As the water is volatilized, the particles tend to be attracted to each other, agglomerating into large particles. During the liquid injection compounding process, particle-to-particle interaction and particle agglomeration can be countered by preventing the particles from coming together during the volatilization of the water. Surfactants are generally used to reduce particle-to-particle attraction. Addition of a surfactant (34) to the liquid (40) to be injected can effectively position the surfactant such that it is available at the point when the water evaporates and the particles begin to agglomerate. In other words, the surfactant is positioned near the particles as the water is evaporating. Having the surfactant located in the water allows the surfactant to work more effectively and helps reduce the amount of particle aggregation during the liquid injection compounding process.

The choice of surfactant relies on many factors. One basic requirement is that the surfactant should be thermally stable. Thermal stability is important due to the heat of polymer compounding and potential secondary extrusion processes. Surfactants can be ionic, non-ionic or amphoteric. In the case of food packaging, non-ionic surfactants are generally preferred since these surfactants do not possess specific surface charges which might modify food properties such as organoleptic profiles. Additionally, the surfactant should be food contact compliant (food-grade). The surfactant chosen should be amphiphilic in nature, Amphiphilic surfactants have a lipophilic end and a hydrophilic end that help to create an effective bridge between the polymer matrix and the water soluble particle. Ideally, the surfactant should serve as a co-solvent for the water soluble particle. This can create a more stable condition during the compounding processing.

The surfactant should have a high Hydrophilic Lipophilic Balance (HLB), HLB values range from 0 to 20 and indicate the extent of hydrophilicity of the material. A low HLB value indicates a highly lipophilic material and a high HLB value indicates a highly hydrophilic material. The surfactant used for the blends described herein should have a high HLB to form a homogenous solution with the water plus particle solution. The proposed process and film solution are best achieved using a surfactant with an HLB value of at least 10. Preferably, the surfactant HLB value is at least 12. More preferably, the surfactant HLB value is at least 15. A preferred surfactant is polyoxyethylene (20) sorbitan monooleate (PS80) which has an HLB of 15.

The HLB can be roughly estimated using a formula that adds value based on the number and type of hydrophilic parts of the surfactant molecule and subtracts value based on the number and type of lipophilic parts of the surfactant molecule. This lends to the understanding that a molecule that has a large number of hydrophilic parts has a higher HLB. Many commercially available surfactants use ethylene oxide units to increase hydrophilicity. Surfactants used for dispersion of water soluble particles in polymer matrices, ideally have an ethylene oxide level (or ethoxylation level) of at least 10 moles of ethylene oxide units per mole of surfactant. A preferred surfactant is polyoxyethylene (20) sorbitan monooleate (PS80) which has an ethoxylation level of 20 moles/mole.

More than one surfactant can be used in the processes, compounds and films described herein. At least one of the surfactants used should have an HLB level as described herein. At least one of the surfactants should have an ethoxylation level as described herein. The other surfactants may or may not have a high HLB level and may or may not have high ethoxylation levels (or ay not have any ethylene oxide units at all).

In some preferred embodiments, the product-contact layer comprises from about 0.0025 g/m² to 4.65 g/m² (0.0016 mg/in² to 3 mg/in²), or from about 0.0078 g/m² to 3.38 g/m² (0.005 mg/in² to 2.5 mg/in²), or from about 0.0155 g/m² to 3.1 g/m² (0.01 mg/in² to 2 mg/in²) of surfactant. In some preferred embodiments, the product-contact layer comprises from about 0.1 wt. % to 6 wt. %, or from about 0.25 wt. % to 5 wt. %, or from about 0.5 wt. % to 4 wt. % of surfactant relative to the total weight of the product-contact layer.

In some preferred embodiments, the compounded polymer comprises from about 0.1 wt. % to 6 wt. %, or from about 0.25 wt % to 5 wt %, or from about 0.5 wt. % to 4 wt % of surfactant relative to the total weight of the compounded polymer.

Particles can be introduced into polymer matrices under a number of different processes. Most of them involve melting the polymer, subsequently adding the particles and using aggressive mixing techniques to break up agglomerated particles and achieve good dispersion. Surfactant can be added to the system to help incorporate particles into the polymer matrix.

Liquid injection compounding is a particularly useful way of introducing water soluble particles into polymer melt. The residual heat from melting the polymer effectively volatilizes the water carrier and the particles are left behind. Through this process, the particles have a tendency to agglomerate into larger particles, visible in the resulting polymer. It has been hypothesized that these agglomerations form due to crystallization of the particles during the liquid injection process. Neighboring particles come together because of strong particle-particle interaction. The result is a heavily agglomerated (both in size of agglomerations and number of agglomerations) particle loading in the polymer matrix causing poor aesthetics. This is especially visible when the polymer matrix is part of a film.

The solution proposed herein is to use a liquid injection compounding process, adding both the water soluble particle and the high HLB value surfactant to the water based liquid phase to be injected into the polymer melt. The water soluble particles do not tend to agglomerate in the water and remain separated in very small particle sizes. Surfactant is also added to the water and is distributed throughout the system.

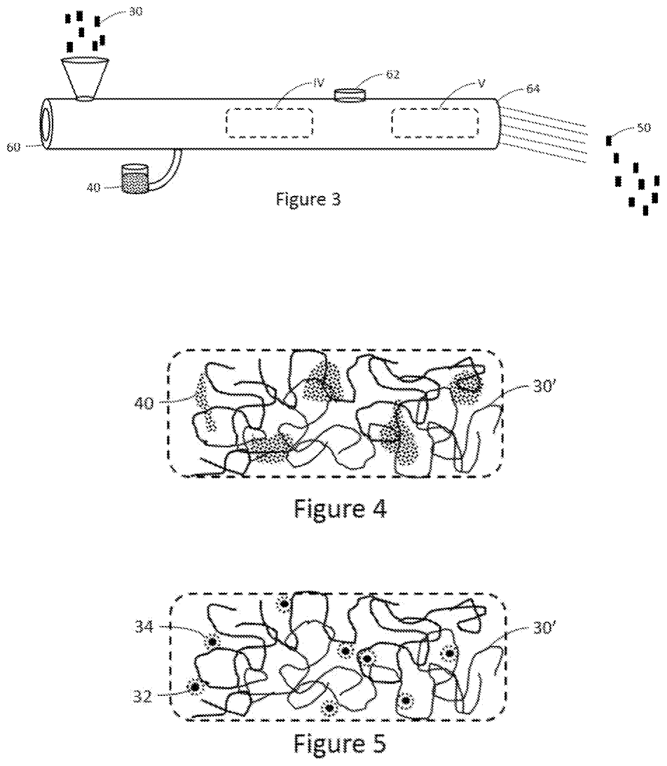

FIG. 3 shows the liquid injection compounding process. A composition that contains the high moisture transmission polymer (30) is introduced into the feed zone of the extruder (60). The composition could contain more than one high moisture transmission polymer. Additionally, the composition could also comprise any other polymers, including those that have a lower moisture transmission. The initial sections of the extruder heat the polymer composition, producing a polymer melt.

In an area of the extruder downstream from the polymer composition feed, liquid injection occurs, feeding and blending the liquid (40) into the polymer melt. At this point, the material inside the extruder is a blend of melted polymer composition (30′) and liquid (40), as shown in the extruder cross-section of FIG. 4 (area IV of FIG. 3). Next, the heat of the extruder and polymer melt stream begin to volatilize the water, and the volatilized gas is removed through a downstream vent (62). FIG. 5 shows the extruder cross section at a point after the water has been removed (area V of FIG. 3). The surfactant (34) covered particles (32) are dispersed throughout the melted high moisture transmission polymer composition (30′). Because the surfactant is located in the water just prior to volatilization, the surfactant is in a location that allows it to be more effective at keeping the particles from migrating toward each other and producing large agglomerations through the compounding process.

Returning to FIG. 3, after the volatilized liquid is removed, the polymer melt blend is pushed through the extruder die (64) and the polymer is cooled and re-solidified, now containing a distribution of particles. As shown in FIG. 3, the extrusion format can be, but is not limited to, strands of polymer which are subsequently cut into pellets of compounded resin (50). As used herein, “compounded resin” refers to a polymer loaded with a dispersion of particles at a particular loading level. The loading level of particles in the compounded resin could be as required for any particular application. Alternatively, the loading level of particles in the compounded resin could be a higher level, creating a masterbatch that is subsequently diluted in a separate extrusion process to produce an article for the end application. Not shown in FIG. 3 is that the compounding process could optionally directly produce the article intended to contain the particle, such as a packaging film.

Returning to FIG. 1, one of the preferred embodiments is a packaging film (20) that comprises a product contact layer (21). The product contact layer comprises a high moisture transmission polymer (30), preferably ethylene vinyl acetate (EVA) copolymer. The product contact layer also comprises a water soluble particle (32), preferably sorbic acid or one of its salts, most preferably potassium sorbate. The product contact layer also comprises a surfactant (34) chosen to effectively reduce the agglomeration of the water soluble particles (32). The product contact layer may be one distinct layer or multiple layers that are connected and functionally perform as one layer.

The product contact layer could contain more than one high moisture transmission polymer. Additionally, the product contact layer could also comprise any other polymers, including those that have a lower moisture transmission. Ideally, the product contact layer is at least 25 wt % high moisture transmission polymer. Preferably the product contact layer is at least 50, 60, 70, 80 or 90% high moisture transmission polymer.

As shown in FIG. 1, the packaging film (20) may also comprise non-product contact layers (22-27). Six non-product contact layers are shown in the non-limiting embodiment of FIG. 1. However, there can be any number of these additional layers. These additional layers may include, but are not limited to oxygen barrier layers, moisture barrier layers, chemical barrier layers, abuse layers, tie or adhesive layers, print/indicia layers, bulk layers, and odor and oxygen scavenging layers. It is contemplated that the product-contact layer can be combined with many different materials such as, but not limited to, plastics, papers, non-woven materials, and metal foils to form various packaging structures. In some preferred embodiments, the packaging films are considered oxygen barrier films and have an oxygen transmission rate (O₂TR) value of less than or equal to 10 cm³/100 in²/24 hours at 1 atmosphere, 23° C. and 0% RH. Multilayer packaging films can be produced by any methods available including co-extrusion, coating and lamination.

It is further contemplated that the packaging films can be converted into various packaging configurations, including but not limited to bags, pillow pouches, stand-up pouches, quad pouches, zipped pouches, over-wraps, lidding films, thermoformed trays, vacuum packages, vacuum skin packaging and the like.

FIG. 2 shows an exemplary application of a packaged product (10). The packaging film (20) previously described is fashioned into a pouch that contains a moist food product (12). Possible food products include produce, fresh meat, processed meat, cheese and other food products with significant moisture content. The food product could be a solid with a small amount of liquid on the surface. The food product could be a liquid with a small amount of solids component. After packaging, the moisture from the food product migrates into the high moisture transmission polymer of the product contact layer of the packaging film and allows for extraction of the water soluble particles dispersed therein. In the preferred embodiments described herein, potassium sorbate particles can be extracted to provide antimicrobial and/or odor reducing functionality for food products such as raw poultry. Other water soluble particles could impart other functionality for other moist products. The water soluble particles can be, but are not limited to, antimicrobial agents, odor reducing agents, flavor imparting agents, or color enhancing agents. The term “antimicrobial agent” used herein describes any water soluble material capable of killing or inhibiting of the growth of bacteria, yeast, fungi, algae, viruses, and/or mold. The term “odor reducing agent” used herein describes any water soluble material capable of reducing odors, by absorption, prevention or any other means.

In order to measure the extraction level of particles from the product-contact layer, film specimens can be prepared by cutting a 120 cm² sample from a film having a product-contact layer composition as specified herein. The film specimens can be placed inside a vial with 10 mL of deionized water. The cumulative amount of particles extracted over time at 23° C. and 1 atm from each film specimen can be determined using UV spectroscopy or other analytical methods. The amount of extraction of the added particle from the product contact layer of the packaging film can be greater than 40% of the initial amount added to the packaging film. Preferably, the amount of added particle extracted from the product contact layer of the packaging film after 2 days of water contact can be greater than 70, 80 or 90%.

### EXAMPLES

Multilayer Film

An ethylene vinyl acetate copolymer (18% vinyl acetate, 30 Ml) was fed into the main feed hopper of a twin screw compounding unit. The polymer was heated and melted as it traveled from the feed zone into the mixing sections of the compounding unit. A liquid solution of 42.8 wt % potassium sorbate and 14.3 wt % polyoxyethylene (20) sorbitan monooleate (PS 80 or Tween 80) in water was introduced and mixed into the polymer melt stream. After some mixing of the liquid solution and the polymer melt, most of the water was vaporized and vented from a downstream vent zone. The resulting polymer mixture of ethylene vinyl acetate copolymer, potassium sorbate particles and surfactant was extruded into strands, water cooled and pelletized into a compounded resin. The compounded resin had a loading of 8.5 wt % potassium sorbate and 2.8 wt % PS 80.

The compounded resin was used in the product contact layer of a multilayer packaging film (Example 1) as shown in FIG. 1. Table 1 contains the specific construction details for the film. A 4 mil (101.6 m) film was produced on a standard blown film line with water quenching.

TABLE 1
Multilayer Packaging Film Structure for Example 1

| Layer as | |
|---|---|
| shown in | |
| FIG. 1 | Materials |
| 21, Product | 92% compounded resin |
| Contact | (18% VA EVA, sorbate particles, PS 80) |
| Layer | 3% polybutylene 5% processing additives |
| 22 | maleic anhydride modified polyethylene blend (tie resin) |
| 23 | 85% nylon 6, 15% nylon 6I/6T |
| 24 | 29 mol % ethylene vinyl alcohol copolymer (EVOH) |
| 25 | 85% nylon 6, 15% nylon 6I/6T |
| 26 | maleic anhydride modified polyethylene blend (tie resin) |
| 27 | 85% nylon 6, 15% nylon 6I/6T |

The Example 1 packaging film produced was tested for transmission haze and clarity using a Haze-gard Plus instrument (available from BYK Gardner). The Example 1 film was found to have haze values of 22.2, 19.3 and 19.7% when tested in randomly selected positions. The Example 1 film was found to have clarity values of 93.2, 96.1 and 94.4% when tested in randomly selected positions.

The Example 1 packaging film produced was tested for extraction. Film specimens were prepared by cutting a 120 cm² sample from the film. The film specimens were placed inside a vial with 10 mL of deionized water. The cumulative amount of particles extracted over time at 23° C. and 1 atm from each film specimen were measured using UV. After 2 days, 95±5% of the particles were extracted from the film samples.

Comparative Example 1 film was produced in a fashion identical to that described for Example 1, with the omission of the surfactant PS 80 from the compounded resin. A particle size evaluation was completed on both Example 1 film samples and Comparative Example 1 film samples. Particles were measured using a TAPPI Dirt Estimation Chart according to TAPPI Test Method T 564. The films were evaluated in three randomly selected 2 inch by 2 inch areas. Particle counts within the areas are given in Table 2, indicating that the film of Example 1 has less particles at every size range and no particles above about 0.3 mm².

TABLE 2
Particle Count by Size, Analysis Area = 2 × 2 inch, 3 samples

| | Particle Surface Area (mm²) | | | | | | | | | | | | | | |
|---|---|---|---|---|---|---|---|---|---|---|---|---|---|---|---|
| | 1 | | | 0.8 | | | 0.2-0.3 | | | 0.07-0.09 | | | 0.05-0.02 | | |
| Comparative | 3 | 5 | 6 | 9 | 6 | 3 | 7 | 15 | 4 | ≥12 | ≥10 | ≥15 | ≥25 | ≥15 | ≥16 |
| Example 1 | | | | | | | | | | | | | | | |
| Example 1 | 0 | 0 | 0 | 0 | 0 | 0 | 3 | 2 | 4 | 3 | 1 | 5 | 2 | 3 | 1 |

Surfactant Characteristics

Compounded resin samples were produced using the liquid injection process as described in the Multilayer Film section of the Examples. The final composition of the compounded resin samples was 8.3±0.5% potassium sorbate and 0.92% surfactant in a polymer matrix of 18% EVA. Various surfactants were tested to verify the effect of ethoxylation level and HLB. Surfactants tested are summarized in Table 3. Samples of the compounded resins were pressed into flat sheets on a Carver press at 156° C. to an approximate thickness of 3 mil (76.2 μm). Additionally, a sample of compounded resin without any surfactant was also pressed into a flat sheet. These sheets were then analyzed using the Haze-gard Plus instrument. Transmission haze and clarity are reported in Table 4. The data indicates that the addition of any surfactant helps improve the haze and clarity of the resultant film. However, a surfactant with a high level of ethylene oxide and higher HLB value results in the best appearance (low haze and high clarity).

TABLE 3
Surfactants Tested for Examples 3-5

| | Moles of | |
|---|---|---|
| Surfactant | ethylene oxide | HLB |
| A: Sorbitan Monooleate | None | 4.3 |
| (Span 80, Croda) | | |
| B: Nonyl Phenol Ethoxylate | 6 | 10.9 |
| (Tergitol NP-6, Dow) | | |
| C: Polyoxyethylene (20) Sorbitan | 20 | 15 |
| Monooleate (Tween 80, Croda) | | |

TABLE 4
Effect of Surfactant on Appearance of Pressed Films

| Surfactant | | |
|---|---|---|
| (see Table 3) | Haze, % | Clarity, % |
| None | 68.2 ± 0.7 | 49.9 ± 0.7 |
| C | 31.7 ± 1.1 | 83.6 ± 0.9 |
| A | 48.23 ± 1.7 | 71.5 ± 2.8 |
| B | 44.3 ± 6.9 | 70.1 ± 9.6 |

Polymer Matrix Characteristics

Compounded resin samples were produced using the liquid injection process as described in the Multilayer Film section of the Examples. The final composition of the compounded resin samples was 8.3±0.5% potassium sorbate and 0.92% PS 80 surfactant in a polymer matrix. Various polymers were tested as the matrix component, including varying levels of VA content. Polymers tested include LDPE, 5% VA ethylene vinyl acetate copolymer and 18% VA ethylene vinyl acetate copolymer. Samples of the compounded resins were pressed into flat sheets on a Carver Press at 150° C. to an approximate thickness of 3 mil (76.2 μm). Also tested were film samples that contained no potassium sorbate or surfactant. Transmission haze and clarity testing results are shown in Table 5. The data indicates that high levels of VA content significantly improve the appearance of the film.

TABLE 5
Effect of Polymer Matrix on Appearance of Pressed Films

| | | | Clarity, % |
|---|---|---|---|
| | | | (samples without |
| | | | potassium sorbate |
| Polymer Matrix | Haze, % | Clarity, % | and surfactant) |
| 18% VA EVA copolymer | 31.7 ± 1.1 | 83.6 ± 0.9 | 96.4 ± 0.5 |
| 5% VA EVA copolymer | 35.2 ± 5.2 | 68.4 ± 4.1 | Not tested |
| LDPE | 35.1 ± 0.4 | 68.8 ± 2.1 | 95.2 ± 1.9 |

Reference throughout this specification to “one embodiment,” “certain embodiments,” “one or more embodiments” or “an embodiment” means that a particular feature, structure, material, or characteristic described in connection with the embodiment is included in at least one possible embodiment. Thus, the appearances of the phrases such as “in one or more embodiments,” “in certain embodiments,” “in one embodiment” or “in an embodiment” in various places throughout this specification are not necessarily referring to the same embodiment. Furthermore, the particular features, structures, materials, or characteristics may be combined in any suitable manner in one or more embodiments.

Unless otherwise indicated, all numbers expressing sizes, amounts, ranges, limits, and physical and other properties used in the present application are to be understood as being preceded in all instances by the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. (canceled)

2. A compounded resin comprising:
i) a high moisture transmission polymer;
ii) between 0.5 and 20 weight percent of a water soluble particle dispersed in the high moisture transmission polymer; and
iii) a surfactant.

3. (canceled)

4. A packaging film comprising a product contact layer comprising a compounded resin of claim 2, wherein any agglomerations of water soluble particles in the packaging film have a size equal to or less than 1.0 mm² when measured using a size estimation chart as described in TAPPI test method T564.

5. A packaging film of claim 4, wherein any agglomerations of water soluble particles in the packaging film have a size equal to or less than 0.8 mm².

6. A packaging film comprising a product contact layer comprising:
i) a high moisture transmission polymer;
ii) at least 0.08 g/m² of a water soluble particle dispersed in the high moisture transmission polymer; and
iii) a surfactant;
wherein any agglomerations of water soluble particles in the packaging film have a size of equal to or less than 1.0 mm² when measured using a size estimation chart as described in TAPPI test method T564.

7. A packaging film according to claim 4, wherein the high moisture transmission polymer is ethylene vinyl acetate copolymer.

8. A packaging film according to claim 7, wherein the ethylene vinyl acetate copolymer has a vinyl acetate content of at least 18%.

9. A packaging film according to claim 4, wherein the water soluble particle is also water extractable.

10. A packaging film according to claim 9 wherein the average cumulative amount of water soluble particle extracted from the product contact layer upon contact with water after 2 days at 23° C. and 1 atm is greater than 40% of the initial amount of particle present in the product contact layer.

11. A packaging film according to claim 4, wherein the water soluble particle is a salt of sorbic acid.

12. A packaging film according to claim 4, wherein the surfactant has an ethoxylation level of at least 10 moles per mole of surfactant.

13. A packaging film according to claim 4, wherein the surfactant has a hydrophilic lipophilic balance (HLB) of at least 10.

14. A packaging film according to claim 4, wherein the film has a haze level less than 35%.

15. A packaging film according to claim 4, wherein the film has a clarity level greater than 70%.

16. A packaged product comprising:
a packaging film comprising a product contact layer comprising:
i) an ethylene vinyl acetate copolymer;
ii) a water soluble particle dispersed in the ethylene vinyl acetate copolymer; and
iii) a surfactant; and
a moist food product.

17. A packaged product of claim 16, wherein the water soluble particle is an antimicrobial agent.

18. A packaged product of claim 16, wherein the water soluble particle is an odor reducing agent.

19. A packaged product of claim 16, wherein the water soluble particle is potassium sorbate.

20. A packaged product of claim 16, wherein the moist food product is raw poultry.
